(19) United States
(12) Patent Application Publication
(10) Pub. No.: US 2011/0119412 A1
(43) Pub. Date: May 19, 2011

(54) PORT-SPLITTER PROVIDING A GUARANTEED PLAYOUT RATE

(76) Inventor: William A. Orfitelli, Pittsford, NY (US)

(21) Appl. No.: 12/617,975

(22) Filed: Nov. 13, 2009

(51) Int. Cl. G06F 13/20

(52) U.S. Cl. 710/20

(57) ABSTRACT

A method for accessing a data storage system, the method implemented by a data processing system and comprising: generating a read-only data access port and a read-write data access port to the data storage system; communicatively connecting a first process to the read-only data access port; communicatively connecting a second process to the read-write data access port; identifying a data-throughput requirement associated with the read-only data access port; and delivering data to the first process at a rate that meets the data-throughput requirement at an expense, if necessary, of a data rate delivered to the second process.

### FIELD OF THE INVENTION

This concept relates to shared storage attached to a media playout device, and in particular a method for controlling access such that the player receives all of the bandwidth it needs with all other processes sharing a secondary lower priority interface.

### BACKGROUND OF THE INVENTION

Today, many media playout devices use hard drives for content storage. Current hard drive based audio/video media players are being hampered by a lack of guaranteed bit-rate. As long as nothing else is requiring access to the storage media, data flow from the storage media to the media player can be guaranteed to satisfy the required minimum drive sustained read performance. However, operations like copying new content onto the storage media, verifying the content's validity, or use of the storage by a computer operating system can all conflict with storage-to-player data transfer and cause media player data starvation, resulting in undesirable playback artifacts.

A similar problem exists in the domain of networked media, where Quality of Service (QoS) is used as a concept to encompass methods of providing bit-rate guarantees to prevent media player starvation.

Another example of this situation is found in digital cinema applications, where today, playout rates can be as high as 290 Mbits/second, coming very close to the sustained transfer limits of common SATA hard drives. Tolerance for playout artifacts is zero in this market, so extraordinary means are taken to prevent media player starvation.

Traditional computer operating system prioritization methods like process priority management do not address I/O starvation. Methods like SGI's (Silicon Graphics International) IRIX GRIO (Guaranteed Rate I/O) approach the problem by creating a controller daemon that aggregates bandwidth requests from any number of nodes and grants or denies requests based on available bandwidth. (For example, see U.S. Patent Application Publication No. 200610028987 to Gildfind, entitled “Method and system for controlling utilisation of a file system.”) Leases for bandwidth are then issued to suitably enabled computer operating system kernels. This approach requires a Storage Array Network (SAN) that is running a shared file system, an example of which is CXFS and a volume manager, XVN, all available from SGI of Fremont, Calif. While this is a very powerful general solution to the media player starvation problem, the complexity of this approach does not lend itself to low cost or high efficiency with a small system.

FIG. 1 illustrates a typical prior art target storage subsystem 100, including a target storage device 110. The target storage device 110 can be a single hard drive or a disk array subsystem. The target storage device 110 controls its own target storage device cache 111 which is used to aggregate read and write requests to maximize device throughput. The target storage device 110 communicates to the host bus adapter and driver 120 using a storage device bus 115, which can use any one of a number of storage device bus interfaces, including SATA. The host bus adapter and driver 120 may or may not control its own host bus adapter and diver cache 121.

The host bus adapter and driver 120 communicates through a unifying layer 130 to the block device interface 140, which accepts and queues requests in a block device interface queue 141. The target storage device cache 111, the host bus adapter and diver cache 121 and the block device interface queue 141 are utilized to maximize performance of the target storage device 110 which incurs performance penalties when requests are not in sequential addresses. The media playout process does not benefit from these, since the playout is typically from large contiguous files. Writes that occur during playout are queued and cached at the various levels, waiting to aggregate a large batch that can be written to the target storage device 110 efficiently. This results in bandwidth dropouts to the playout process, as the caches are periodically flushed, either because there is no more room or as they get old.

FIG. 2 illustrates an example of a single port block device 200, such as would be typical of a prior art media player. A target storage subsystem 205 is typically mounted on a file system mount point 210 that permits simultaneous access from multiple processes, including playout processes 230. The file system utilizes a file system mount cache 211. In today's media players, the playout processes 230 shares the file system mount point 210 with non-playout processes 220. Requests for access to the target storage subsystem 205 are mediated between the competing processes by the file system mount point 210 which cannot distinguish between critical bandwidth needs and non-critical needs. Typically, the playout processes 230 must maintain their own playout processes buffer 231 to compensate for bandwidth fluctuations caused by non-playout processes 220 as they get priority, and to compensate for bandwidth dropouts caused by cache flushing activity. Large buffers are sometimes required, which can result in the undesirable side effect of delaying the start of playout as the buffer fills.

U.S. Pat. No. 6,961,813 to Grieff et al., entitled “System and method for providing multi-initiator capability to an ATA drive,” teaches a method where two ATA initiators can share a hard drive. With this approach, a dual-ported hard drive shares a common arbitrator that communicates to two attached computers. No provision is made to provide guaranteed high-priority access through either port. U.S. Pat. No. 6,948,036 to Grieff et al., entitled “System and method for providing multi-initiator capability to an ATA drive,” extended this concept to Serial ATA (SATA).

### SUMMARY

The above-described problem is addressed and a technical solution is achieved in the art by a system and a method for accessing a data storage system comprising a first data access port, and the method comprising:

generating a read-only data access port and a read-write data access port to the data storage system from the first data access port;

communicatively connecting a first process to the read-only data access port;

communicatively connecting a second process to the read-write data access port;

identifying a data-throughput requirement associated with the read-only data access port; and

delivering data to the first process at a rate that meets the data-throughput requirement at an expense, if necessary, of a data rate delivered to the second process.

The method of the present invention has the advantage that it gives a media player a guaranteed-bandwidth high-priority port to access the storage media, while all processes using the lower-priority port receive the remainder of the bandwidth.

It has the additional advantage that it enables low-priority access to a storage media without the risk of interfering with high-priority access to time-sensitive presentation data, thereby providing added flexibility for how the storage media is used in a media player system.

In addition to the embodiments described above, further embodiments will become apparent by reference to the drawings and by study of the following detailed description.

### BRIEF DESCRIPTION OF THE DRAWINGS

The present invention will be more readily understood from the detailed description of exemplary embodiments presented below considered in conjunction with the attached drawings, of which:

FIG. 1 illustrates a target storage subsystem;

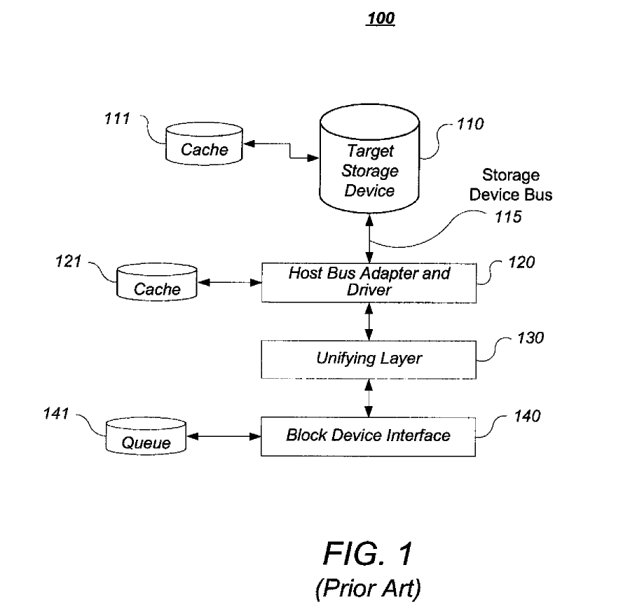

FIG. 2 illustrates the target storage subsystem used as a shared device in a typical system without priority control;

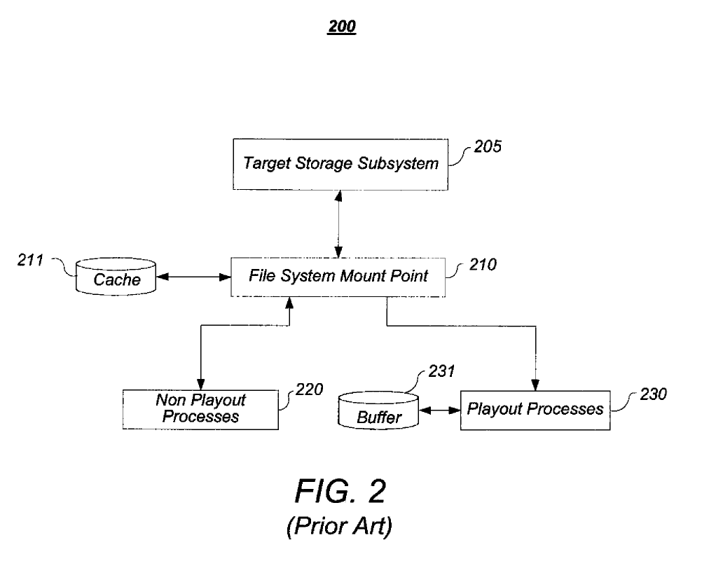

FIG. 3 illustrates a system for using a Linux dual port device as a port splitter, according to an embodiment of the present invention; and

FIG. 4 illustrates an exploded view of the rate and throttle calculation method of FIG. 3, according to an embodiment of the present invention.

It is to be understood that the attached drawings are for purposes of illustrating the concepts of the invention and may not be to scale.

### DETAILED DESCRIPTION

The present invention represents a method for accessing file storage for the purposes of playing audio, video and any other time-sensitive presentation data at a guaranteed throughput while simultaneously and aggressively accessing the file storage for other purposes without impacting playout. In one embodiment of the present invention, the file storage is interfaced to a media player and to non-playout clients using a Linux dual port block device acting as a port splitter, in which the file storage is exposed as two ports. One port is a high-priority port having rate guaranteed read-only access. The second port is a low-priority port having a read-write capability. The port splitter is provided with an interface with which to write the bandwidth required by the high-priority port. This interface is controlled by the media player and is written to frequently to reflect the media player's current demand. The low-priority port provides any number of processes access to the file storage without knowledge of the bandwidth needs of the media player. Processes accessing the file storage using the low-priority port need not have any throttling mechanisms, and the maximum remaining bandwidth is made available at all times. The dual ported nature of the file storage can be hidden from the file system because one port (the high-priority port) is mounted read-only. This method can be used on a single drive, or used in conjunction with a RAID. By receiving data rate requests from the playout process, by measuring the instantaneous bandwidth performance of the file storage to the player, and by calculating an optimum throttle, other processes are allowed access to the shared storage with optimum total bandwidth.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting.

It should be noted that, unless otherwise explicitly noted or required by context, the word “or” is used in this disclosure in a non-exclusive sense.

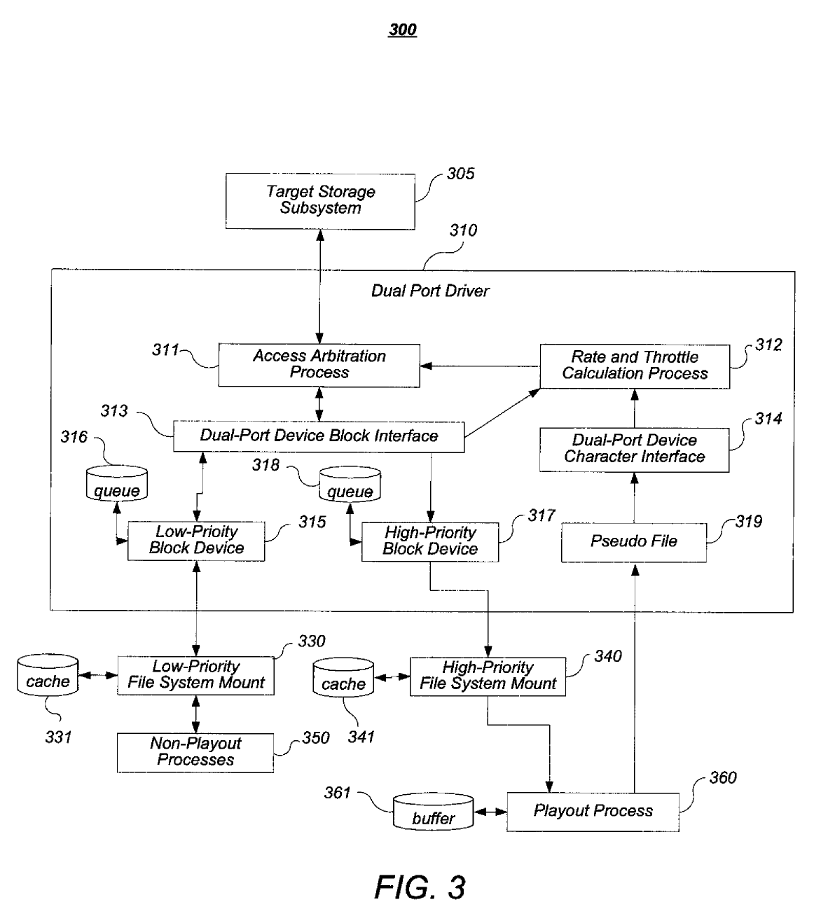

FIG. 3 illustrates a system for a dual port block device 300 according to an embodiment of the present invention. The dual port block device 300 uses a dual port driver 310 as a rate controlled port splitter, which provides guaranteed bandwidth access from a target storage subsystem 305 to a playout process 360, and which provides optimized bandwidth to any non-playout processes 350.

The target storage subsystem 305 is acquired by the dual port driver 310 which receives exclusive access through a data access port. The dual port driver 310 creates two ports as low-priority block device 315 (a low-priority read-write data access port) and high-priority block device 317 (a high-priority read-only data access port). The low-priority block device 315 has an associated low-priority block device queue 316 and the high-priority block device 317 has an associated high-priority block device queue 318. An interface to the high-priority block device 317 is a read-only port having rate guaranteed access, in this case creating high-priority file system mount point 340. The high-priority file system mount point 340 has an associated high-priority file system mount point cache 341, and is used by the playout process 360 to access the target storage subsystem 305. The low-priority block device 315 has a lower priority read-write capability, and is used to create low-priority file system mount point 330. The low-priority file system mount point 330 has an associated low-priority file system mount point cache 331, and is used to access the target storage subsystem 305 from one or more non-playout processes 350. The dual port driver 310 includes a pseudo file 319 with which bandwidth requests from the playout process 360 are accepted.

Any number of non-playout processes 350 can access the storage without knowledge of the bandwidth needs of the playout process 360. Non-playout processes accessing the storage through the dual port driver 310 need not have any throttling mechanisms, and the maximum remaining bandwidth is made available at all times. The dual ported nature of the storage media is hidden from the file system, as long as the high-priority file system mount point 340 is read only. Processes interact with the two views of the target storage subsystem 305 as if they were connected directly to it, issuing read commands and write commands as needed. Depending on the file system used, it may be required to re-mount the read-only port to see the effects of write operations occurring through the low-priority file system mount point 330.

Within the dual port driver 310, access arbitration process 311 takes place by examining the current output from the rate and throttle calculation process 312 and inserting delays in the handoff of lower-priority requests to the target storage subsystem 305 to achieve the current throttle setting. Queuing of requests on the low-priority block device 315 is disabled during the delay times. A dual-port device character interface 314 accepts bandwidth requests for the playout process 360. (The playout process 360 may be comprised of a plurality of individual playout processes for audio, video and metadata such as subtitles.) The playout process 360 requests bandwidth by writing to the pseudo file 319 as often as practical. The bandwidth allotted to the low-priority interface is the minimum peak sustained bandwidth of the target storage subsystem 305 minus the bandwidth requested by the playout process 360. For example, if a particular target storage subsystem 305 is characterized as having a sustained minimum peak bandwidth of 100 Mbytes/second, and the sum of the high priority bandwidth requests is 20 Mbytes/second, the low priority interface will be allowed to reach the difference, 80 Mbytes/second, before being throttled down.

The rate control used by the rate and throttle calculation process 312 is modeled as a classical proportional control system problem, including proportional (P), integral (I) and derivative (D) terms. This can be referred to as PID control. As is well-known in the art, PID control functions can be described by the following equation:

$$u ( t ) = {K}_{c} ( {K}_{p} e ( t ) + {K}_{i} {\int }_{0}^{t} e ( τ ) d τ + {K}_{d} \frac{d e ( t )}{d t} )$$

where u(t) is the PID control function, e(t) is a control error function, Kₚ is an parameter that scales a proportional term, Kᵢ is a parameter that scales an integral term, K_{d} is a parameter that scales a derivative term, K_{c} is a parameter that scales the combined terms, and t is a measurement time. (The set point value is also known in the art as a bias value or an offset value.) The PID control function is used to allow the dual port driver 310 the ability to react to sudden rate changes, as well as to calibrate to slower changes.

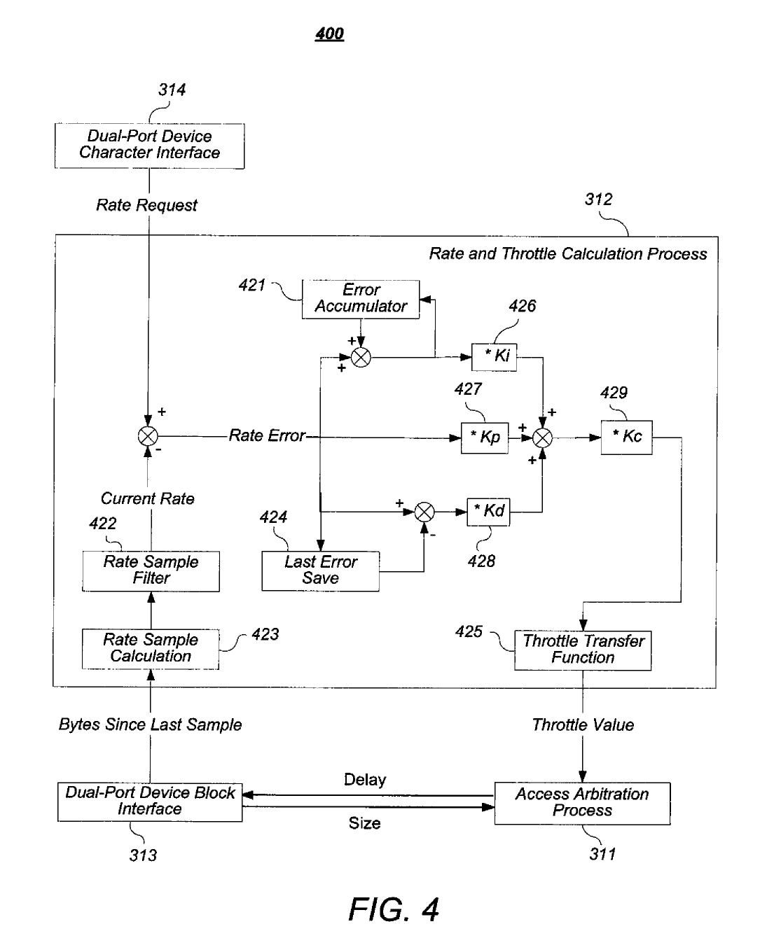

FIG. 4 illustrates a PID control function implementation 400 that can be used within the rate and throttle calculation process 312. Rate requests in Mbytes/second originate from the dual-port block device character interface 314. They are combined with the bytes since last sample provided by the dual-port device block interface 313, to create a throttle value in Mbytes/second that is applied to the access arbitration process 311.

In a preferred embodiment of the present invention, the rate and throttle calculation process 312 is run using 10 msec sample intervals. At each sample interval, the total number of bytes processed by the dual-port device block interface 313 is used by the rate sample calculation 423 to calculate the current rate for each of the two ports in terms of Mbytes/sec. The rates are filtered with a rate sample filter 422 to remove fluctuations due to characteristics of the target storage subsystem 305, such as seek delays. The resulting current rate is subtracted from the rate request to create a rate error. The rate error is added to the output of the error accumulator 421 and multiplied by an integral term parameter 426 (Kᵢ) to create an integral correction term. In a preferred embodiment of the present invention, the error accumulator 421 sums the total of the last 1000 Rate error samples. The rate error is also multiplied by a proportional term parameter 427 (Kₚ) to create a proportional correction term. The rate error for the previous sample is stored in last error save 424. The last error save 424 is subtracted from the rate error, and the result multiplied by a derivative term parameter 428 (K_{d}) to form a differential correction term. The integral correction term, the proportional correction term and the differential correction term are summed and multiplied by a combined term parameter 429 (K_{c}), which is input to a throttle transfer function 425 which determines a throttle value, which is expressed in terms of a percentage of a maximum rate for the target storage subsystem 305. The throttle value is input to the access arbitration process 311. The access arbitration process 311 provides a delay value in msec to the dual-port device block interface 313. The delay value is applied to the next access by a non-playout process 350 (FIG. 3). In a preferred embodiment of the present invention, the dual-port device block interface 313 passes information about the size of the next data transfer request by a non-playout process 350 to the access arbitration process 311, and this size value is used in the process of determining the delay value.

With the method of the present invention, the size of the playout process buffer 361 can be reduced drastically relative to the prior art embodiments. This is possible because the rate of filling and emptying the low-priority file system mount point cache 331 and the low-priority block device queue 316 is now controlled by the dual-port device block interface 313. Other than saving on the costs associated with RAM storage, another benefit of a reduced size for the playout process buffer 361 is an improvement in playout process startup time, since the need for buffer filling without playing (pre-fill) is reduced. In addition, the non playout processes 350 are given the optimum bandwidth without impacting the playout process 360.

According to one embodiment of the present invention, the port splitter is implemented as a hardware ATA port splitter that exists as a separate physical entity from the computing platform running the player process and exposes two physical ATA interfaces (of any of the ATA variants such as SATA or PATA). One of the physical ATA interfaces provides the high-priority port, while the other physical ATA interface provides the low-priority port. Rate information is communicated to the port splitter either over a low-speed interface such as 12C, or is communicated to the port splitter using ATA metadata carried along with the high-priority port communications. The ATA port splitter can be implemented as an integrated circuit that resides on a computer circuit board, as an expansion board to a computer (e.g., a PCI expansion board), or as a stand-alone device with external interfaces such as eSATA or USB.

According to one embodiment of the present invention, the port splitter is implemented using an ATA-over-Ethernet protocol, wherein a target storage device exposes two virtual Ethernet storage devices, one corresponding to the high-priority port, the other corresponding to the low-priority port. Rate information is conveyed to the port splitter from the media player via an Ethernet control port, or via an inter-process communication port if the media player resides on the same computer as the port splitter.

In a preferred embodiment, instructions for communicatively connecting processes to the read-write data access port (low-priority file system mount point 330) and the read-only data access port (high-priority file system mount point 341), together with instructions for identifying the data-throughput requirement associated with the read-only data access port and delivering data to that port at a rate that meets the data-throughput requirement at an expense, if necessary, of a data rate delivered to the second process, are implemented as a kernel driver of a general purpose computer operating system (e.g., Linux, Unix, Windows or Mac OS X).

In one embodiment of the present invention, the port splitter is used in a multimedia system such as a digital cinema system to provide access to audio, video and any other time-sensitive presentation data stored on a data storage device at a guaranteed throughput while simultaneously and aggressively providing access to the data storage device. The method of the present invention solves the critical problem of preventing media player starvation in a market where there is zero tolerance for errors. The method of the present invention can be used to playout video and audio data to a digital cinema video projection system via the high-priority file system mount point 341. At the same time, access to the data storage system is also enabled via the low-priority file system mount point 330. The low-priority file system mount point 330 can be used for purposes such as copying media files to the data storage system for the next movie that will be shown on the video projection system. With prior art solutions, it is necessary to wait until times when the video projection system is not being used to copy new media files to the data storage system to insure that there were no interruptions during the video projection. Therefore the present invention has the advantage of providing more flexibility as to when and how the data storage system can be used.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

### PARTS LIST

100 Target storage subsystem
110 Target storage device
111 Target storage device cache
115 Storage device bus
120 Host bus adapter and diver
121 Host bus adapter and diver cache
130 Unifying layer
140 Block device interface
141 Block device interface queue
200 Single port block device
205 Target storage subsystem
210 File system mount point
211 File system mount cache
220 Non-playout processes
230 Playout processes
231 Playout processes buffer
300 Dual port block device
305 Target storage subsystem
310 Dual port driver
311 Access arbitration process
312 Rate and throttle calculation process
313 Dual-port device block interface
314 Dual-port device character interface
315 Low-priority block device
316 Low-priority block device queue
317 High-priority block device
318 High-priority block device queue
319 Pseudo file
330 Low-priority file system mount point
331 Low-priority file system mount point cache
340 High-priority file system mount point
341 High-priority file system mount point cache
350 Non-playout process
360 Playout process
361 Playout process buffer
400 PID control function implementation
421 Error accumulator
422 Rate sample filter
423 Rate sample calculation
424 Last error save
425 Throttle transfer function
426 Integral term parameter
427 Proportional term parameter
428 Derivative term parameter
429 Combined term parameter

What is claimed is:

1. A method for accessing a data storage system, the method implemented by a data processing system and comprising:
generating a read-only data access port and a read-write data access port to the data storage system;
communicatively connecting a first process to the read-only data access port;
communicatively connecting a second process to the read-write data access port;
identifying a data-throughput requirement associated with the read-only data access port; and
delivering data to the first process at a rate that meets the data-throughput requirement at an expense, if necessary, of a data rate delivered to the second process.

2. The method of claim 1, wherein information specifying the data-throughput requirement associated with the read-only data access port is received from the first process.

3. The method of claim 1, wherein data is delivered to the second process based at least upon an analysis of a proportional control process.

4. The method of claim 3, wherein the proportional control process is a proportional-integral-derivative control process.

5. The method of claim 4, wherein the proportional-integral-derivative control process computes a control error representing a difference between the data-throughput requirement and a current data-throughput being delivered to the first process, and wherein the proportional-integral-derivative control process controls the rate that data is delivered to the second process using a control function, the control function including a proportional term which is proportional to the control error, an integral term which is proportional to an integral of the control error, and a derivative term which is proportional to a derivative of the control error.

6. The method of claim 1, wherein the step of delivering data to the first process includes:
identifying a current data-throughput being delivered to the first process;
identifying a data-throughput difference representing a difference between the data-throughput requirement of the first process and the current data-throughput being delivered to the first process; and
delivering data to the second process via the read-write data access port based at least upon an analysis of the data-throughput difference.

7. The method of claim 6, wherein the analysis of the data-throughput difference includes calculating a time delay, and wherein the delivery of data to the second process via the read-write data access port is delayed by a time interval specified by the time delay.

8. The method of claim 7, wherein the time delay is further calculated based at least upon a prior-calculated time delay calculated at an earlier time.

9. The method of claim 8, wherein the time delay is decreased from the prior-calculated time delay when the data-throughput difference indicates that the data-throughput requirement of the first process is less than the current data-throughput being delivered to the first process.

10. The method of claim 8, wherein the time delay is increased from the prior-calculated time delay when the data-throughput difference indicates that the data-throughput requirement of the first process is more than the current data-throughput being delivered to the first process.

11. The method of claim 1, wherein the first process is a multimedia process.

12. The method of claim 11, wherein the multimedia process is a digital cinema video projection process.

13. The method of claim 1, wherein the communicative connection between the first process and the read-only data access port is implemented via ATA over Ethernet.

14. The method of claim 1, wherein the communicative connection between the second process and the read-write data access port is implemented via ATA over Ethernet.

15. A system for accessing data, the system comprising:
a data storage system;
a read-only data access port and a read-write data access port, both communicatively connected to the data storage system;
a data processing system; and
a memory system communicatively connected to the data processing system and storing instructions configured to cause the data processing system to implement a method for accessing data from the data storage system, wherein the instructions comprise:
a) instructions for communicatively connecting a first process to the read-only data access port;
b) instructions for communicatively connecting a second process to the read-write data access port;
c) instructions for identifying a data-throughput requirement associated with the read-only data access port; and
d) instructions for delivering data to the first process at a rate that meets the data-throughput requirement at an expense, if necessary, of a data rate delivered to the second process.

16. The system of claim 15, wherein the data processing system and the memory system are dedicated solely to controlling the read-only data access port and the read-write data access port.

17. The system of claim 16, wherein the data processing system, the memory system, the read-only data access port and the read-write data access port are located together within a single device dedicated solely to delivering data to the first process at a rate that meets the data-throughput requirement at an expense, if necessary, of a data rate delivered to the second process.

18. The system of claim 17, wherein the single device is in a transportable form configured to communicatively connect to any of a plurality of data storage devices.

19. The system of claim 15, wherein the data processing system and the memory system provide general computing functionality in addition to controlling the read-only data access port and the read-write data access port.

20. The system of claim 19, wherein the memory system further comprises instructions implementing an operating system of a general purpose computer system.

21. The system of claim 20, wherein the instructions (a)-(d) are kernel instructions of the operating system.

22. The system of claim 21, wherein the communicative connection between the first process and the read-only data access port is implemented via ATA over Ethernet, and wherein the communicative connection between the second process and the read-write data access port is implemented via ATA over Ethernet.

23. A port splitter for a data storage system, the port splitter comprising:
a storage system data access port adapted to communicatively connect to a data storage system;
a read-only data access port and a read-write data access port, both communicatively connected to the storage system data access port;
a data processing system; and
a memory system communicatively connected to the data processing system and storing instructions configured to cause the data processing system to implement a method for accessing data from the data storage system, wherein the instructions comprise:
a) instructions for communicatively connecting a first process to the read-only data access port;
b) instructions for communicatively connecting a second process to the read-write data access port;
c) instructions for identifying a data-throughput requirement associated with the read-only data access port; and
d) instructions for delivering data to the first process at a rate that meets the data-throughput requirement at an expense, if necessary, of a data rate delivered to the second process.

24. The port splitter of claim 23, wherein the read-only data access port or the read-write data access port or both provide ATA interfaces.

25. The port splitter of claim 23, wherein the read-only data access port or the read-write data access port or both provide USB interfaces.

26. The port splitter of claim 23, wherein the port splitter is provided as part of an integrated circuit board for a computer.

27. The port splitter of claim 23, wherein the port splitter is provided as a stand-alone device having an external interface for adapted for connecting to the data storage device.
